(19) United States
(12) Patent Application Publication
(10) Pub. No.: US 2012/0209585 A1
(43) Pub. Date: Aug. 16, 2012

(54) METHOD AND SYSTEM FOR DETERMINING BENEFITS OF OUTSOURCING ON A COMPUTER SYSTEM

(75) Inventor: Andrew Loach, Berkhamsted (GB)

(73) Assignee: CPA SOFTWARE LIMITED, St. Helier (UK)

(21) Appl. No.: 13/391,034

(22) PCT Filed: Aug. 18, 2009
(86) PCT No.: PCT/IB09/06855

§ 371 Date: May 3, 2012

(51) Int. Cl. G06F 9/44

(52) U.S. Cl. 703/21

(57) ABSTRACT

A method and system for determining benefits of outsourcing is provided in a computer system. The method includes calculating on the computer system a first set of resource requirements to conduct one or more of a plurality of processes within an entity. The first set of resource requirements are calculated by performing a predefined set of computations on a set of data associated with the entity. The method further includes simulating on the computer system a second set of resources requirements to conduct one or more of the plurality of processes using one or more offshore personnel. The method further includes rendering on the computer system one or more benefits of using the one or more offshore personnel based on the first set of resource requirements and the second set of resource requirements.

### BACKGROUND

The invention relates generally to the field of outsourcing. More specifically the invention relates to methods and systems for determining benefits of outsourcing.

Many corporations across the world have been focusing on methods for reducing costs so as to increase profits. Outsourcing is widely accepted as one of the most effective means for achieving reduction in cost, while maintaining the quality of products and services. However, outsourcing may not always lead to cost savings.

For outsourcing, a system which facilitates outsourcing of one or more processes from a corporation has to be established, which involves some investments. After establishing the system, the corporation may choose a process for outsourcing. The process thus outsourced may not make much business sense over a period of time, taking into consideration the reduction in the cost by outsourcing the process and the investment made for establishing the system. The corporation may thus decide to abandon the decision of outsourcing the process. Thereby wasting the investments made for establishing the system.

Conventionally, the decisions regarding which processes should be outsourced are taken randomly by some corporations without performing any analysis. Thus, very often outsourcing of such processes may not lead to cost savings in the long run.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages.

FIG. 1 is a block diagram of a system for determining one or more benefits of outsourcing, in accordance with an embodiment.

FIG. 2 is a flowchart illustrating a method for determining one or inure benefits of outsourcing, in accordance with an embodiment.

FIG. 3 is a flowchart illustrating a method for determining one or more benefits of outsourcing, in accordance with another embodiment.

FIG. 4 is a flowchart illustrating a method. for determining one or more benefits of reassigning a process assigned to one or more external onshore entities, in accordance with an embodiment.

FIG. 5A and 5B show preformatted forms generated to collect data from one or more persons in an entity, in accordance with an exemplary embodiment.

FIG. 6 depicts results of computations performed on a set of data collected from a law firm, in accordance with an exemplary embodiment.

### DETAILED DESCRIPTION

Before describing in detail embodiments, it should be observed that the embodiments reside primarily in combinations of method steps and apparatus components related to method and system for determining benefits of outsourcing in a computer system Accordingly, the apparatus components and method steps have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed, or inherent to such process, method, article, or apparatus. An element proceeded by “comprises . . . a” does not, without more constraints, preclude the existence of additional identical elements in the process, method, article, or apparatus that comprises the element.

Various embodiments of provide methods and systems for determining benefits of outsourcing on a computer system. The method includes calculating on the computer system a first set of resource requirements to conduct one or more of a plurality of processes within an entity. The first set of resource requirements are calculated by performing a predefined set of computations on a set of data associated with the entity. The method, further includes simulating on the computer system a second set of resources requirements to conduct one or more of the plurality of processes using one or more offshore personnel. The method further includes rendering on the computer system one or more benefits of using the one or more offshore personnel based on the first set of resource requirements and the second set of resource requirements.

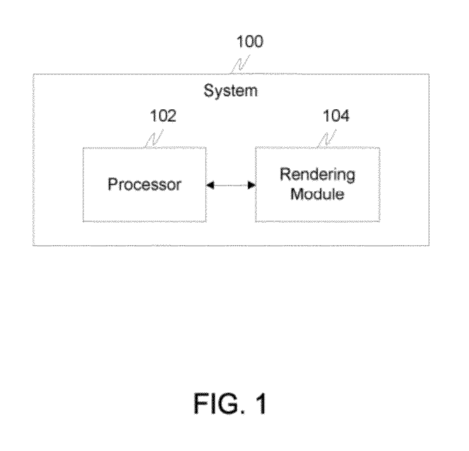

FIG. 1 is a block diagram of a system 100 for determining: one or more benefits of outsourcing, in accordance with an embodiment. System 100 includes a processor 102 and a rendering module 104. Processor 102 generates preformatted forms to collect a set of data associated with an entity. Examples of the entity may include, but are not limited to a law firm, a product company, a Bank, an educational institution, an individual, and a service company. The preformatted forms may be generated by printing them on paper. Alternatively, the preformatted forms may be generated on rendering module 104. Rendering module 104 may include one or more of, but is not limited to a Liquid Crystal Display (LCD) screen, a touch screen, a Cathode Ray Tube ('CRT) screen, a plasma screen, a Surface-conduction Electron-emitter Display (SED) screen, an Organic Light-Emitting Diode (OLED) screen, and a projector screen. It will be apparent to a person skilled in the art that generation of the preformatted forms is not limited to the above listed methods.

Rendering module 104 may be a part of a computer system (not shown in FIG. 1). Examples of the computer system may include, but are not limited to a personal computer, a laptop, a palm top, a cell phone, a Personal Digital Assistant

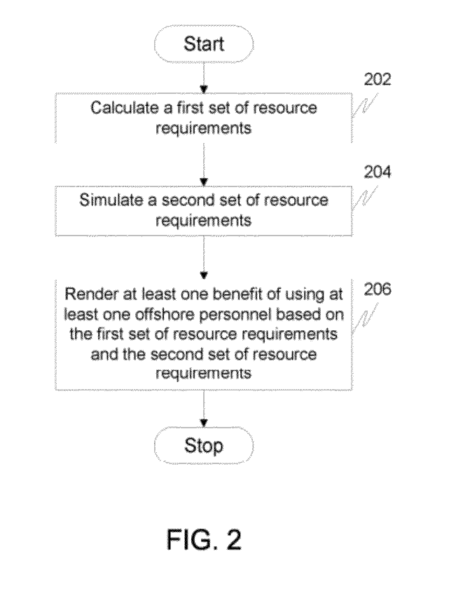

After collecting the set of data, processor 102 calculates a first set of resource requirements to conduct one or more of a plurality of processes within the entity. Each of the plurality of processes is one of a legal process, a business process, and a knowledge process. The first set of resource requirements are calculated by performing a predefined set of computations on the set of data associated with the entity. After the calculation, processor 102 simulates a second set of resource requirements to conduct one or more of the plurality of processes using one or more offshore personnel. The second set of resource requirements may be simulated on rendering module 104. This is further explained in conjunction with FIG. 2.

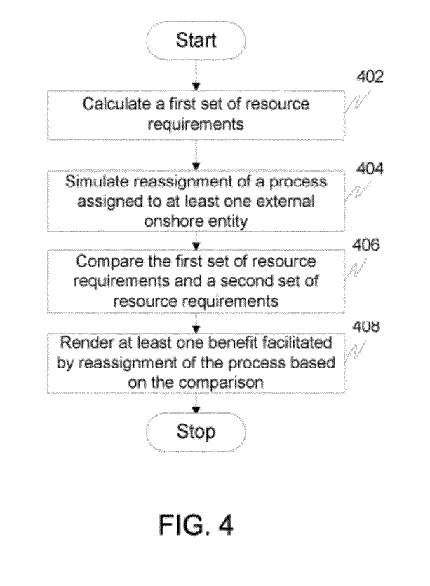

For simulating the second set of resource requirements, processor 102 simulates redeployment of one or more Full Time Employees (FTEs) of the entity to conduct a process of the plurality of processes. The process is initially assigned to one or more external onshore entities. An external onshore entity is a firm that is located in the same geographical location as the entity. For example, a law firm A located in a country Alpha may want to avail services of another law firm B, which is also located. in the country Alpha. In this case, the law firm B will be an external onshore entity for the law firm A. In addition to this, processor 102 also simulates redirection of a process of the plurality of processes to the one or more offshore personnel. The process is initially assigned to one or more external onshore entities. The redirection and redeployment are explained in detail in conjunction with FIG. 4.

Thereafter, processor 102 compares the first set of resource requirements with the second set of resource requirements to determine the one or more benefits of using the one or more offshore personnel. Based on the comparison, rendering module 104 renders the one or more benefits. The one or more benefits may be rendered by displaying them in the form of one or more of, but not limited to graphs, numerals, and text. Alternatively, the one or more benefits may be rendered in form of one of an email. Short Messaging Service (SMS), and Multimedia Messaging Service (MMS). It will be apparent to a person skilled in the art that rendering of the one or more benefits is not limited to the above listed methods. The one or more benefits are farther explained in detail in conjunction with FIG. 2.

FIG. 2 is a flowchart illustrating a method for determining one or more benefits of outsourcing, in accordance with an embodiment. The method is performed. in a computer system. The computer system has been explained in detail in conjunction with FIG. 1.

An entity is interested in outsourcing one or more processes of a plurality of processes from the entity. Therefore, one or more benefits of outsourcing are determined and are communicated to the entity to encourage the entity to outsource. For this, processor 102 generates preformatted forms to collect a set of data associated with the entity Generation of preformatted forms has been explained in conjunction with FIG. 1. The set of data includes one or more of FTE headcount, geographical locations, number of offices, organization structure, workload, work complexity, work type, internal expenditure, external expenditure, and external onshore entities employed. This is further explained in detail in conjunction with FIG. 4.

Thereafter, at step 202, processor 102 calculates a first set of resource requirements to conduct one or more of the plurality of processes within the entity. The first set of resource requirements may include one or more of, but is not limited to a headcount, infrastructure, time, and finances. The headcount may include FTEs, part time employees, consultants, and employees of an external onshore entity engaged. by the entity. Infrastructure may include office space, furniture, systems, and other facilities provided to FTEs. Similarly, finance may include salaries of FTEs, salaries of part time employees and consultants, money paid to external onshore entities, and miscellaneous expenditure, for example, travel expenses, training, benefits, and pensions. It will be apparent to a person skilled in the art that the resource requirements are not limited to the above listed resources.

The first set of resource requirements are calculated by performing a predefined set of computations on the set of data. The predefined set of computations may include distribution of work across the offices in the geographical locations of the entity. In this, the distribution of the total work done by the entity may be depicted in percentages across the offices in the geographical locations. Alternatively, the distribution may be depicted using graphs, for example. Pie chart and Bar chart.

Additionally, the predefined set of computations may include breakdown of work based on one or more of work complexity, work type, internal department work allocation in the entity, FTE work allocation, experience of an FTE handling allocated work, designation of an FTE handling allocated work, and external onshore entity work allocation. In other words, a combination of two or more of the above listed details may be used to depict breakdown of work of the entity. For example, a pie chart may be used to depict the percentage of work handled by each internal department of the entity. Similarly, a pie chart may be used to depict the percentage of a particular type of work handled by FTEs at various designations. Additionally, a pie chart may be used to depict the percentages of various types of work allocated to an external onshore entity. Similarly, a pie chart may be used to depict the percentage of work allocated to an external onshore entity based on work complexity.

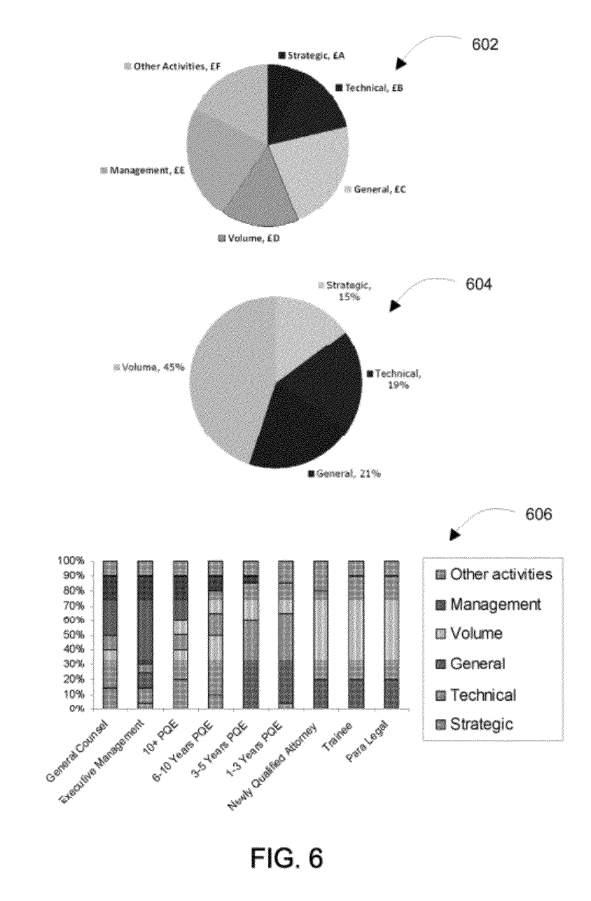

The predefined set of computations may further include one or more of categorization of the external expenditure incurred on the external onshore entities and categorization of the internal expenditure incurrent within the entity. For example, a pie chart may be used. to depict these categorizations in percentages. This is further explained in detail in conjunction with FIG. 6.

The performing of the predefined set of computations is rendered on rendering module 104 by processor 102. Processor 102 may also render the first set of resource requirements on rendering module 104. Alternatively, processor 102 may print the first set of resource requirements on a paper, which may thereafter be circulated to one or more persons in the entity. For example, if the entity is a law firm, the first set of resource requirements would be disclosed to a general counsel of the law firm. Rendering the predefined set of computations and the first set of resource requirements, enables the target audience, i.e., the entity, to easily evaluate results of these predefined set of computation performed on the set of data in real time. This helps in removing any scope of discrepancy or doubt in the entity.

After the calculation of the first set of resource requirements, processor 102 simulates a second set of resource requirements to conduct one or more of the plurality of processes using one or more offshore personnel, at step 204. The second set of resources requirements may include one or more of, but is not limited to a headcount, infrastructure, time, and finances. The headcount in this case includes the number of offshore personnel engaged, FTEs, part time employees, consultants, and employees of an external onshore entity engaged. Infrastructure may include setting up systems for coordinating with the one or more offshore personnel. Finances (in addition to what the entity already spends) may include salaries for the one or more offshore personnel, increased travel budget owing to frequent trips of one or more FTEs and offshore personnel, and money spent on relationship management. In other words, the second set of resource requirements are the overall resources that would be utilized if one or more of the plurality of processes are outsourced.

Processor 102 may simulate the second set of resource requirements on rendering module 104. As a result of this, the target audience, i.e., the entity viewing rendering module 104 is able to get an estimate in real time regarding the actual resource requirements for outsourcing one or more processes. Therefore, the entity will not actually have to outsource one or more processes to determine what would be the resource requirements for outsourcing. The entity may analyze the simulation and then taking a judicious decision regarding outsourcing, and thereby save time and money.

For simulating the second set of resource requirements, processor 102 simulates reassignment of a process of the plurality of processes. The process is initially assigned to one or more external onshore entities. Reassignment of the process may be simulated by simulating redeployment of one or more FTEs to conduct the process. Alternatively, reassignment of the process may be simulated by simulating redirection of the process to the one or more offshore personnel. This is further explained in detail in conjunction with FIG. 4.

Thereafter, processor 102 compares the first set of resource requirements with the second set of resource requirements to determine the one or more benefits of using the one or more offshore personnel. The process of comparison may be rendered on rendering module 104. Based on the comparison, at step 206, rendering module 104 renders the one or more benefits of using the one or more offshore personnel. The one or more benefits include one or more of FTE headcount reduction, finance savings, time saving, and reduction of investment in infrastructure. Usually the cost of an FTE is much more than the cost of an offshore employee. Therefore, replacing an FTE with an offshore employee leads to a lot of financial savings. Also, with the reduction of FTE headcount, the expenses on infrastructure, benefits, and pensions and other miscellaneous necessities are considerably reduced.

As the one or more benefits are rendered on rendering module 104 for a target audience (i.e., the entity) in real time, therefore, the level of appreciation on the entity side, regarding benefits of outsourcing increases manifold.

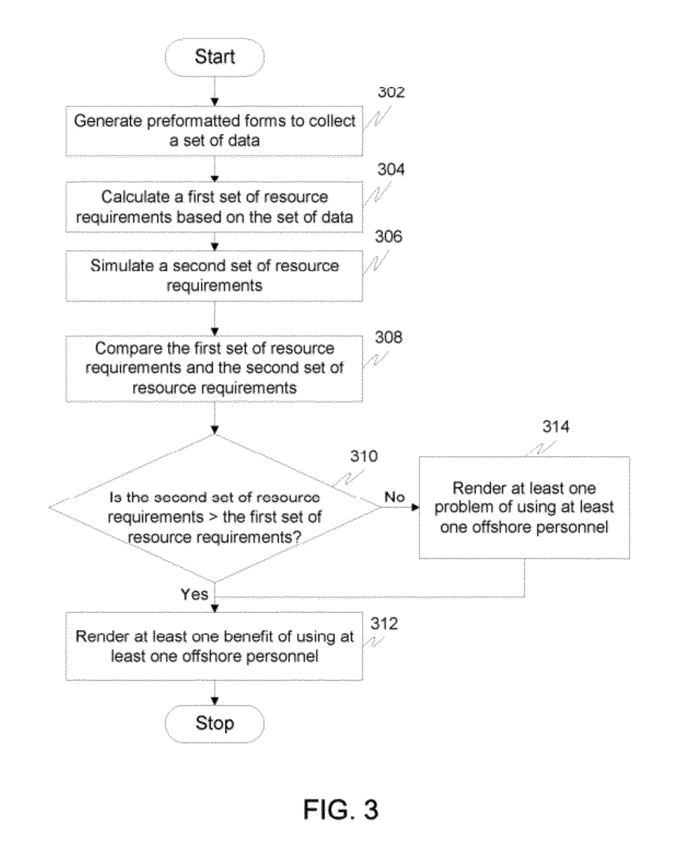

FIG. 3 is a flowchart illustrating a method for determining one or more benefits of outsourcing, in accordance with another embodiment. The method is performed on a computer system. The computer system has been explained in conjunction with FIG. 1.

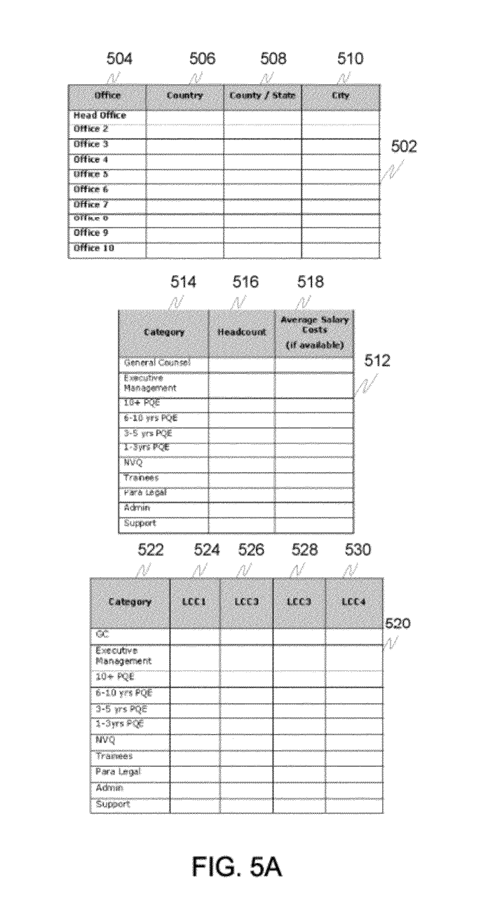

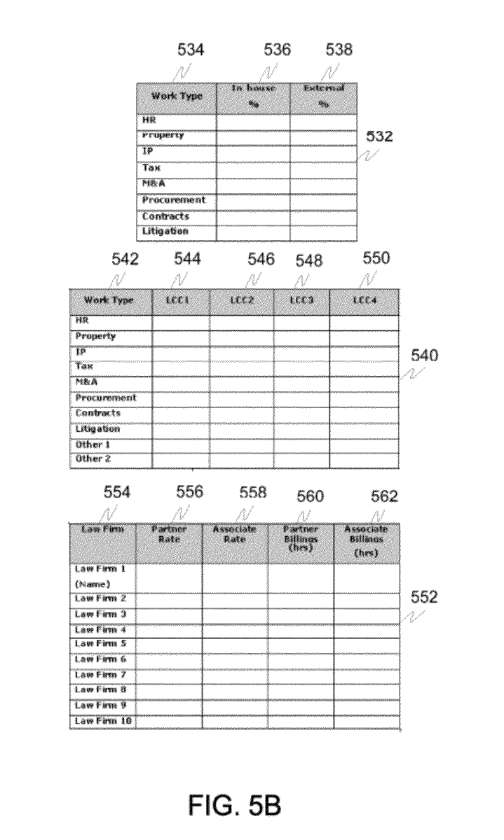

At step 302, processor 102 generates preformatted forms to collect a set of data associated with an entity. When the preformatted forms are generated by printing on paper, the preformatted forms are circulated among one or more persons associated with the entity. The one or more persons fill in details required in the preformatted forms. Alternatively, the preformatted forms are rendered on rendering module 104, for example, through a web page or a User Interface (UI) of a software. Thereafter, one or more persons in the entity fill in various fields of the web page or the UI of the software to provide the set of data. Examples of the preformatted forms are explained in detail in conjunction with FIG. 5A and 58. If no one in the entity is willing to fill in details in the preformatted forms, available market data can be used to fill in details in the preformatted forms. For example, companies are usually not comfortable in disclosing the salaries that they pay to their FTEs. Thus, in this case, market data regarding salaries of individuals at various levels in a particular field may be used.

Based on the set of data collected using the preformatted forms, processor 102 calculates a first set of resource requirements to conduct one or more of the plurality of processes within the entity, at step 304. This has been explained in detail in conjunction with FIG. 2. As the set of data is collected from one or more persons within the entity, therefore, the target audience, i.e., the entity, can completely rely on the calculation of the first set of resource requirements.

At step 306, processor 102 simulates a second set of resource requirements to conduct one or more of the plurality of processes using one or more offshore personnel. This has been explained in conjunction with FIG. 2. Thereafter, at step 308, processor 102 compares the first set of resource requirements with the second set of resource requirements. At step 310, a check is performed to determine if the second set of resource requirements are less than the first set of resource requirements.

Rendering module 104 renders one or more benefits of using the one or more offshore personnel, at step 312, if the second set of resource requirements are less than the first set of resource requirements. This implies that outsourcing one or more of the plurality of processes may lead to substantial cost savings and thus the one or more of the plurality of processes should be outsourced to the one or more offshore personnel.

Referring back to step 310, if the second set of resource requirements are greater than the first set of resource requirements, rendering module 104 renders one or more problems of using the one or more offshore personnel, at step 314. This implies that one or more of the plurality of processes are not suitable for outsourcing and therefore they should not be outsourced to the one or more offshore personnel.

As the comparison of first set of resource requirements and the second set of resource requirements is conducted on rendering module 104 and rendered in real time, therefore, the target audience, i.e., the entity can completely rely on the method used for comparison. Also, the method listed above gives a subjective analysis on benefits of outsourcing one or more processes. Moreover, the method also indicates one or more problems that may arise if one or more processes are outsourced. This helps in building trust with the en regarding the method used for determining benefits of outsourcing.

FIG. 4 is a flowchart illustrating a method. for determining one or more benefits of reassigning a process assigned to one or more external onshore entities, in accordance with an embodiment. The method is performed on a computer system. The computer system has been explained in detail in conjunction with FIG. 1.

Processor 102 generates preformatted forms. Thereafter, a set of data associated with an entity is collected based on the preformatted forms filled by one or more persons in the entity. This has been explained in detail in conjunction with FIG. 3. In this embodiment, the set of data specifically includes expenditure on one or more external onshore entities, names of the one or more external onshore entities engaged, type of work allocated to the one or more external onshore entities, and complexity of work allocated to the one or more external onshore entities.

Based on the set of data, processor 102 calculates a first set of resource requirements to conduct one or more of a plurality of processes using one or more external onshore entities. The first set of resource requirements are calculated by performing a predefined set of computations on the set of data. The predefined set of computations include breakdown of work based on one or more of work complexity and external onshore en work allocation. For example, external onshore entities include three law firms, i.e., a law firm A, a law firm B, and a law firm C. In this case, the total work allocated to the external onshore entities is broken down according to work allocated to the law firm A, the law firm B, and the law firm C. The law firm A is allocated. 30% of the total work, the law firm B is allocated 20% of the total work, and the law firm C is allocated 50% of the total work. The breakdown may be depicted in the form of a pie chart.

By way of another example, the work complexity is divided into three categories, i.e., extremely complex, moderately complex, and marginally complex. Based. on these categories and the external onshore entities employed, the work is broken down according to percentage of work from a category of work complexity allocated to an external onshore entity. In this case, 90% of the extremely complex work allocated to the external onshore entities is allocated to the law firm A, 10% the extremely complex work allocated to the external onshore entities is allocated to the law firm B. Similarly, 80% of the moderately complex work allocated to the external onshore entities is allocated to the law firm B and 20% of the moderately complex work allocated to the external onshore entities is allocated to the law firm C. The marginally complex work is handled by the entity itself. This analysis may be depicted using a bar graph or a pie chart.

Additionally, the predefined set of computations may include categorization of external expenditure incurred on external onshore entities. For example, out of the total amount spent on external onshore entities, 60% may be spent on a law firm A, 30% on a law firm B, and 10% on a law firm C. The categorization may be displayed using a pie chart.

After calculating the first set of resource requirements, processor 102 simulates reassignment of a process of the plurality of processes, at step 404. The process is initially assigned to one or more external onshore entities. In one scenario, reassignment may be simulated by simulating redeployment of one or more FTEs of the entity to conduct the process that is assigned to the one or more external onshore entities. Referring back to the step of simulation in FIG. 2, the availability of the one or more FTEs is facilitated by the use of one or more offshore personnel.

As the one or more offshore personnel are simulated to be engaged to conduct one or more processes of the plurality of processes, therefore, one or more FTEs would be available to perform additional processes. These one or more FTEs are simulated to be redeployed to perform the process, which was initially assigned to an external onshore entity. This reduces the amount of work that is assigned to the one or more external onshore entities. For example, a law firm has a total FTE count of 60 who are assigned 60% of the work of the entity. 40% of the work is assigned to one or more external onshore law firms. If out of the 60% of the work assigned to FTEs, 20% work is outsourced to one or more offshore personnel, 20% of the total FTE count, i.e., 12 FTEs will be available to perform additional work. These 12 FTEs can then be redeployed to perform 20% to 50% of the work assigned to the one or more external onshore law firms, based on the complexity of the work. This would reduce the utilization of the one or more external onshore law firms by 32% up to 20%. Moreover, as the charging rates of external onshore law firms are much higher than the salaries paid to FTEs, therefore, considerable amount of money can be saved.

Alternatively, in another scenario, reassignment may be simulated by simulating redirection of the process to the one or more offshore personnel. in this case, the process that is assigned to an external onshore entity is simulated to be conducted. by the one or more offshore personnel. This also reduces the amount of work that is assigned to the one or more external onshore entities. The process is redirected based on the type of the process. Generally, the process is a volume work for which expertise in a particular field is not required.

The determination regarding the type of process is made based on the breakdown of work, as mentioned in the description of step 304. For example, a pie chart regarding the breakdown of work according to work complexity and work allocation to one or more external onshore law firms is available. The pie chart is then used to determine that 80% of the moderately complex work allocated to the external onshore entities, is allocated to the law firm B. This moderately complex work can be performed by one or more offshore personnel. Therefore, this 80% moderately complex work is redirected to the one or more offshore personnel, thereby reducing utilization of the law firm B and saving cost.

Thereafter, at step 406, processor 102 compares the first set of resource requirements and the second set of resource requirements to determine one or more benefits facilitated by reassignment of the process assigned to the one or more external onshore entities. Processor 102 renders this comparison on rendering module 104. Therefore, the target audience, the entity interested in outsourcing is able to appreciate the comparison in real time. This increases the reliability of the entity on the one or more benefits of outsourcing.

The one or more benefits of reassignment include reduction of one or more part of finances that the entity incurred. for using the one or more external onshore entities. There is a substantial difference between the charges of an external onshore entity and salaries paid to an FTE. Moreover, in the case of redirection, the difference between the charges of an external onshore entity and the charges of an offshore employee is much greater. Thus the savings are much higher. An additional benefit in the case of redeployment is career satisfaction in the one or more FTEs that have been redeployed. These one or more FTEs get to work on more complex and interesting work, which was earlier assigned to the one or more external onshore entities, thus leading to career satisfaction and FTE retention.

Rendering module 104 then renders the one or more benefits for the entity, i.e., the target audience, at step 408. The one or more benefits may be rendered as graphical representations. Alternatively, the one or more benefits of finances may be rendered in the form of numbers or text. It will be apparent to a person skilled in the art that the one or more benefits may be rendered using other method not listed above.

FIG. 5A and 5B show preformatted forms generated to collect data from one or more persons in a law firm, in accordance with an exemplary embodiment. A preformatted form 502 is used to collect data regarding the number of offices of the law firm and the geographical locations of the offices of the law firm. In preformatted form 502, a column 504 is used to fill name of the offices of the law firm. A column 506, a column 508, and a column 510 are used to fill locations of the offices of the law firm. Based on this information of the law firm, a predefined computation may be performed to generate a pie chart depicting distribution of work in percentages across offices of the law firm in different geographical locations.

Similarly, a preformatted form 512 is used to collect data regarding total FTE headcount and their respective salaries. A column 514 in preformatted form 512 is used to fill in details of various organizational levels in the law firm. The organizational levels in the law firm include, General counsel (GC), executive management, PQE's with different level of experience, NVQ, trainees, paralegals, Admin, and support. A column 516 is used to fill in the headcount at each organizational level filled in column 514. Further, a column 518 is used to fill average salary of an FTE at each level filled in column 514. If data regarding average salaries is not entered by the people in the law firm, then column 518 can be automatically populated based on average salaries given in other law firms at various organizational levels. This data can be used to compute the total internal expenditure in the law firm. Additionally, a graph may be used to depict distribution of internal expenditure across various organizational levels in the law firm. This graph may be used to make a decision regarding outsourcing.

Data regarding division of complexity of work across various organizational levels in the law firm is collected using a predetermined form 520. In preformatted form 520, a column 522 is used to fill in details of various organizational levels in the law firm. A column 524, a column 526, a column 528, and a column 530 are used to fill in details for the amount of work falling in four different regions of a Legal Complexity Curve (LCC), i.e., LCC1, LCC2, LCC3, and LCC4.

Column 524 is used to fill in details for the amount of work, which is associated with LCC1, allocated to people across various organizational levels in the law firm. Work associated with LCC1 may be performed by people who have experience of 10 to 15 years or more and have dealt with work relating to significant business financial, regulatory, and legal impact. Similarly, column 526 is used to fill in details for LCC2, column 528 for LCC3, column 530 for LCC4. Work associated with LCC2 may be performed by people who have experience of five to 10 years and. have in depth knowledge of a broad range of technical and complex legal subject matters. Similarly, work associated with LCC3 may be performed by newly qualified lawyers or junior lawyers who have experience of two to five years. This work is generic in nature but requires qualified legal expertise. Lastly, work associated. with LCC4 includes standardized legal agreements or volume work, which can be done by newly qualified lawyers, paralegals, or admin staff. Based on these details filled in preformatted form 520, breakdown of work according to work complexity and experience of employees of the law firm can be depicted. This may be depicted using a column chart, as explained in detail in conjunction with FIG. 6.

Further, a preformatted form 532 is used to collect information regarding the percentage of a particular type of work done within the law firm and the percentage of the particular type of work assigned to external onshore law firms. In preformatted form 532, a column 534 is used to fill in data regarding type of work done by the law firm. Additionally, a column 536 is used to fill in data regarding percentage of a type of work done by the law firm itself and a column 538 is used to fill in data regarding percentage of the type of wok done by one or more external onshore law firms. This data is helpful in determining total percentage of a particular type of work done within the law firm and the total percentage of that particular type of work done by an external onshore law firm.

Similarly, information regarding what amount of a particular type of work done in the law firm falls under different levels of complexity of work is collected using a preformatted form 540. This information is collected for the work done internally in the law firm. A column 542 in preformatted form 540 is used to fill in data regarding type of work done by the law firm. A column 544 is for LCC1, a column 546 is for LCC2, a column 548 is for LCC3, and a column 550 is for LCC4. This information is also collected for the work done by external onshore law firms. This is further explained in detail in conjunction with FIG. 6.

If external onshore law firms are engaged, then data regarding the billing rates of the external onshore law firms is obtained using a preformatted form 552. In preformatted form 552, a column 554 is used to fill in the names of all the external onshore law firms engaged by the law firm. A column 556 is used to fill in per hour charging rates of a partner in each of the external onshore law firms. Similarly, a column 558 is used to fill in per hour charging rates of an associate in each of the external onshore law firms. A column 560 and a column 562 are used to determine the total number of hours that have been spent by the external onshore law firms for the law firm. This data is used to determine expenditure of the law firm incurred by engaging the external onshore law firms.

It will be apparent to a person skilled in the art that the above listed preformatted forms can be generated on a paper by printing or on rendering module 104.

FIG. 6 depicts results of computations performed on a set of data collected from a law firm, in accordance with an exemplary embodiment.

Based on the set of data collected from one or more of the preformatted forms depicted in FIG. 5A and 5B, a pie chart 602, a pie chart 604, and a column chart 606 are generated. Pie chart 602 is generated when a computation for determining the money spent within the law firm based on the complexity of work is performed on the set of data. Pie chart 602 depicts that out of total internal expenses of the law firm, £A has been spent on strategic work, £B has been spent on technical work, £C has been spent on general work, £D has been spent on volume work, £E has been spent on management work, and £F has been spent on other activities. Instead of giving the actual expenses, a percentage of the total expenses for each category of complexity of work may be shown in pie chart 602. Pie chart 602 thus gives a clear picture to the law firm regarding the amount of money spent in performing works of different complexities. The law firm can thus observe that a major chunk of the total expenditure is because of general work, management work, and volume work. Based on this, the law firm may decide to outsource these to one or more offshore personnel, as very less expertise is required for such work. Pie cart 602 may also represent the amount of money spent for performing work of different complexities by engaging external onshore law firms.

Pie chart 604 depicts the distribution of work based on the complexity of work performed by external onshore law firms. Pie chart 604 depicts that although the law firm may have engaged the external onshore law firms to perform strategic work mostly, however, strategic work is the least performed work and volume work is the mostly performed work. This information depicted by pie chart 604 may be very helpful in redirection of work assigned to external onshore law firms to one or more offshore personnel.

A predefined computation may be performed on the data to check if people at various organizational levels have to perform a particular type of work that they ideally should not be doing. Column chart 606 depicts this analysis which can be used to take a decision for outsourcing. For example, as depicted in column chart 606, executive management, and PQE having experience more than 3 years are involved in some volume work, which ideally is not meant for people at this level. Therefore, in addition to saving money, outsourcing this volume work would save a lot of time of people at this level.

Various embodiments provide methods and. systems for determining benefits of outsourcing. In this method, a set of data is collected from people associated with a target audience interested in outsourcing. Thereafter, a first set of resource requirements for performing one or more processes within the entity are calculated using some computations performed on the set of data. The computations and the first set of resource requirements are displayed on a computer screen in real time to the target audience interested in outsourcing. Thus the target audience is easily able to evaluate results of these computations. Thus removing any scope of discrepancy or doubt in the target audience regarding authenticity of the computations. Also, as the set of data is collected from the target audience itself, thus they can completely rely on the calculation of the first set of resource requirements.

Additionally, as the simulated resource requirements for outsourcing is displayed on a computer screen, therefore, the target audience is able to get an estimate in real time regarding the actual resource requirements, when one or more processes would be outsourced. Therefore, the entity will not actually have to outsource one or more processes to determine what would be the resource requirements for outsourcing. The entity may analyze the simulation and then take a judicious decision regarding outsourcing, and thereby save time and money. Further, as benefits of outsourcing are displayed on the computer screen for the target audience in real time, therefore, the level of appreciation regarding benefits of outsourcing increases manifold.

Those skilled in the art will realize that the above recognized advantages and other advantages described herein are merely exemplary and are not meant to be a complete rendering of all of the advantages of the various embodiments of the invention.

The method of determining benefits of outsourcing as described in the invention or any of its components may be embodied in the form of a computing device. The computing device can be, for example, but not limited to, a general-purpose computer, a programmed microprocessor, a micro-controller, a peripheral integrated circuit element, and other devices or arrangements of devices, which are capable of implementing the steps that constitute the method of the invention,

What is claimed is:

1. In a computer system, a method of determining benefits of outsourcing, the method comprising:
calculating on the computer system a first set of resource requirements to conduct at least one of a plurality of processes within an entity, wherein the first set of resource requirements are calculated by performing a predefined set of computations on a set of data. associated with the entity;
simulating on the computer system a second set of resources requirements to conduct at least one of the plurality of processes using at least one offshore personnel; and
rendering on the computer system at least one benefit of using the at least one offshore personnel based on the first set of resource. requirements and the second set of resource requirements.

2. The method of claim 1, wherein simulating the second set of resources requirements comprises simulating reassignment of a process of the plurality of processes assigned to at least one external onshore entity.

3. The method of claim 2, wherein a benefit of the at least one benefit comprises reduction of at least a part of finances incurred for using the at least one external onshore entity to conduct the process, the benefit being facilitated by reassignment of the process.

4. The method of claim 2, wherein simulating reassignment comprises simulating redeployment of at least one Full Time Employee (FTE) of the entity to conduct the process.

5. The method of claim 4, wherein availability of the at least one FTE is facilitated by using the at least one offshore personnel.

6. The method of claim 2, wherein simulating reassignment comprises simulating redirection of the process to the at least one offshore personnel.

7. The method of claim 6, wherein the process is redirected based on type of the process.

8. The method of claim 1 further comprising comparing the first set of resource requirements with the second set of resource requirements to determine the at least one benefit.

9. The method of claim 8, wherein the second. set of resource requirements are less than the first set of resource requirements.

10. The method of claim 1, wherein each of the first set of resource requirements and the second set of resource requirements comprise one of headcount, infrastructure, time, and finances.

11. The method of claim 1, wherein the set of data comprises at least one of FTE headcount, geographical locations, number of offices, organizational structure, workload, work complexity, work type, external expenditure, external onshore entities employed, and internal expenditure.

12. The method of claim 11, wherein the predefined set of computations comprises:
distribution of work across the offices in the geographical locations of the entity;
breakdown of work based on at least one of: work complexity, internal department work allocation in the entity, FTE work allocation, experience of an FTE handling allocated work, designation of an FTE handling allocated work, and external onshore entity work allocation;
categorization of the external expenditure incurred on the external onshore entities; and
categorization of the internal expenditure incurred within the entity.

13. The method of claim 1, wherein each of the plurality of processes is one of a legal process, a business process, and a knowledge process.

14. The method of claim 1, wherein the at least one benefit comprises at least one of FTE headcount reduction, finance savings, time saving, and reduction of investment in infrastructure.

15. The method of claim 1 further comprising generating preformatted forms to collect the set of data associated with the entity.

16. A system for determining a east one benefit of outsourcing, the system comprising:
a processor configured to:
calculate a first set of resource requirements to conduct at least one of a plurality of processes within an entity, wherein the first set of resource requirements are calculated by performing a predefined set of computations on a set of data associated with the entity;
simulate a second set of resources requirements to conduct at least one of the plurality of processes using at least one offshore personnel; and
rendering module configured to render at least one benefit of using the at least one offshore personnel based on the first set of resource requirements and the second set of resource requirements.

17. The system of claim 16, wherein the processor is further configured to simulate redeployment of at least one Full Time Employee (FTE) of the entity to conduct a process of the plurality of processes assigned to at least one external onshore entity.

18. The system of claim 16, wherein the processor is further configured to simulate redirection of a process of the plurality of processes to the at least one offshore personnel, the process being assigned to at least one external onshore entity.

19. The system of claim 16, wherein the processor is further configured to compare the first set of resource requirements with the second set of resource requirements to determine the at least one benefit.

20. The system of claim 16, wherein the processor is further configured to generate preformatted forms to collect the set of data associated with the entity.

21. The system of claim 16, wherein the rendering module comprise at least one of a Liquid crystal display (LCD) screen, a touch screen, a Cathode Ray Tube (CRT) screen, a plasma screen, a Surface-conduction Electron-emitter Display (SED) screen, an Organic Light-Emitting Diode (OLED) screen, and a projector screen.

22. A computer program product for determining benefits of outsourcing, the computer program product comprising a computer usable medium having a computer readable program code embodied therein, the computer readable program code performing:
calculating on the computer system a first set of resource requirements to conduct at least one of a plurality of processes within an entity, wherein the first set of resource requirements are calculated by performing a predefined set of computations on a set of data associated with the entity;
simulating on the computer system a second set of resources requirements to conduct at least one of the plurality of processes using at least one offshore personnel; and
rendering on the computer system at least one benefit of using the at least one offshore personnel based on the first set of resource requirements and the second set of resource requirements.
